(19) United States
(12) Patent Application Publication
(10) Pub. No.: US 2010/0307239 A1
(43) Pub. Date: Dec. 9, 2010

(54) Food Preparation and Presentation Cylinder with Measurement Indicia

(76) Inventor: Yehonathan Goldstein, Washington, DC (US)

Correspondence Address: ITALIA IP, 3500 WEST OLIVE AVE., SUITE 300, BURBANK, CA, 91505, US

(21) Appl. No.: 12/477,345

(22) Filed: Jun. 3, 2009

(51) Int. Cl. G01F 19/00

(52) U.S. Cl. 73/427

(57) ABSTRACT

A food preparation and presentation cylinder with measurement indicia used for preparing and presenting food. The food preparation and presentation cylinder with measurement indicia can also be in the shape of a cube, a cone or other polygon. The cylinder is made of PYREX™, any type of transparent polypropylene or any transparent material. The cylinder can also be made of heat resistant and food grade material and is freezer safe, oven safe and microwave oven safe. The cylinder's measurement indicia can be a plurality of circumferential rings around the circumference of the cylinder or incremental etched markings on the front side and the back side of the cylinder.

### BACKGROUND

This application relates generally to a food preparation and presentation cylinder with measurement indicia. More specifically, this application relates to a transparent food preparation and presentation cylinder with measurement indicia used for preparing and presenting food.

### SUMMARY

Cooking is a passion for many people, whether it is in a person's kitchen at home or in the commercial kitchen of a chef in a five star restaurant. People are creative with the dishes that they make and take great pride in how they are presented. Convenience and simplicity are also important, as well as the functionality of the cookware that people use to make and create their dishes. Many times the cookware must also be versatile to be used for hot and cold dishes.

Although many people say that cooking is an art form, precise measurements are critical to the novice and can even be important to the professional chef. This is particularly true of exotic dishes that chefs and cooks try to make for the first time, which is becoming more prevalent in today's shrinking international world. Whether it be a housewife in Michigan trying to make salsa or a restaurant owner in Eastern Europe trying to make beef and broccoli, measurements are very important to a person making a new exotic dish for the first time, regardless of where they are in the world.

There seems to be an endless array of cookware that seems to have been in use for decades and even centuries. There also seems to be an endless array of “displayware” that is designed to display and enhance a cook's or chef's dishes. Even though both have been around for a longtime, not many inventors and users have combined the two into a piece of cookware that can also be used for display purposes. Even fewer have combined the two in a functional and creative way. No one to date has combined the two into a transparent food container and display case with measurement indicia. Such a transparent food container and display case with measurement indicia is not only needed by cooks and chefs worldwide, but would also be quite successful in the global marketplace.

In particular, this application discloses a food preparation and presentation cylinder with measurement indicia used for preparing and presenting food. The food preparation and presentation cylinder with measurement indicia can also be in the shape of a cube, a cone or other polygon. The cylinder is made of PYREX™, any type of transparent polypropylene, or any transparent material. The cylinder can also be made of heat resistant and food grade material and is freezer safe, oven safe and microwave oven safe. The cylinder's measurement indicia can be a plurality of circumferential rings around the circumference of the cylinder or incremental etched markings on the front side and the back side of the cylinder.

In particular, this application discloses a food preparation and presentation cylinder with measurement indicia that allows a user to consistently reproduce accurate and precise layered foods.

### BRIEF DESCRIPTION OF THE DRAWINGS

The drawings, when considered in connection with the following description, are presented for the purpose of facilitating an understanding of the subject matter sought to be protected.

FIG. 1 is an environmental perspective view of a first embodiment of a food preparation and presentation cylinder with measurement indicia.

FIG. 2 is a side perspective view of a food preparation and presentation cylinder with measurement indicia.

### DETAILED DESCRIPTION

While the food preparation and presentation cylinder with measurement indicia present is described with reference to several illustrative embodiments described herein, it should be clear that the present invention should not be limited to such embodiments. Therefore, the description of the embodiments provided herein is illustrative of the present invention and should not limit the scope of the invention as claimed. In addition, while the following description references a food preparation and presentation cylinder with measurement indicia, it will be appreciated that the invention may be any food preparation and presentation cylinder with measurement indicia.

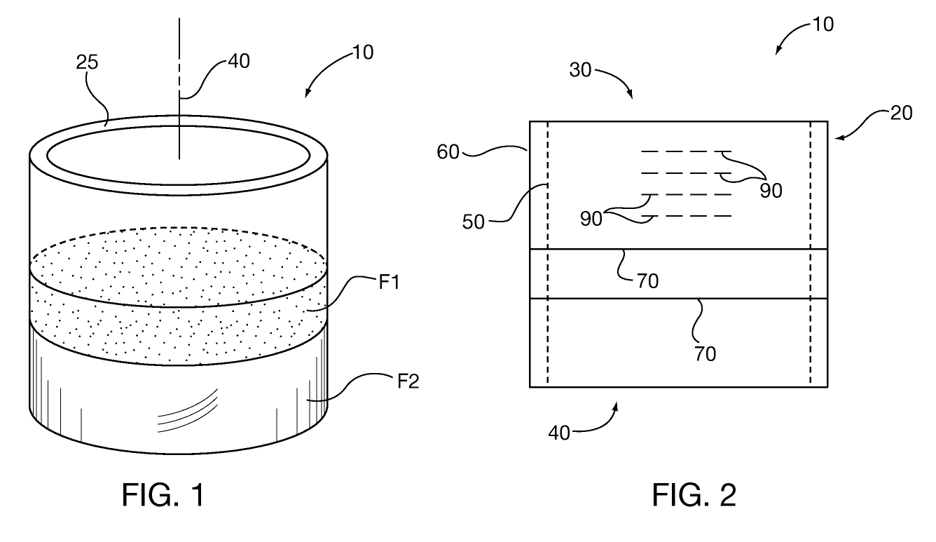

Referring now to FIG. 1, a first embodiment of a food preparation and presentation cylinder with measurement indicia 10 used for preparing and presenting food F is depicted. The food preparation and presentation cylinder with measurement indicia 10 can be in the shape of a cube, a cone or other polygon that is well known to those skilled in the art. As is illustrated in FIG. 1, the food preparation and presentation cylinder with measurement indicia 10 shown is in the shape of a cylinder.

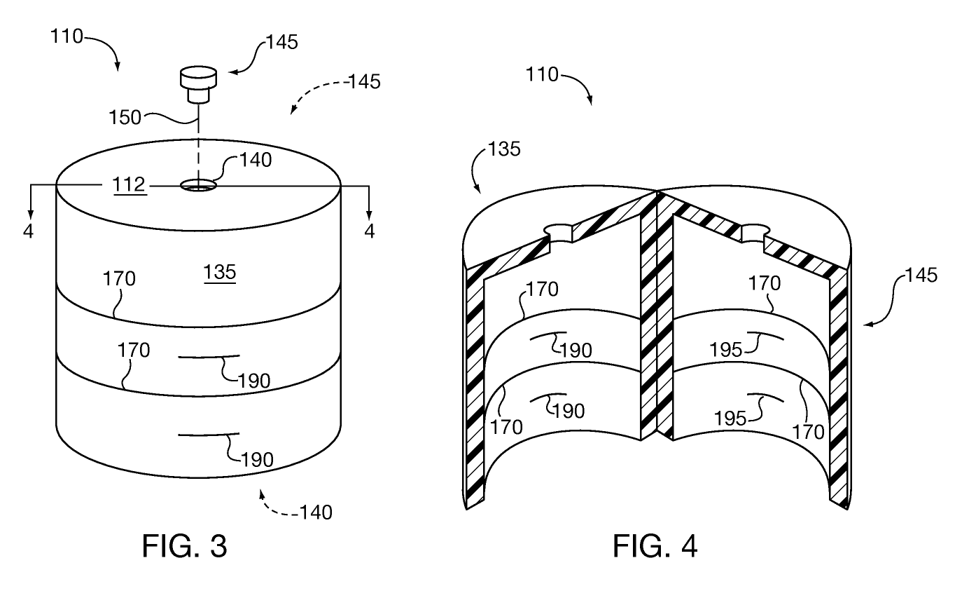

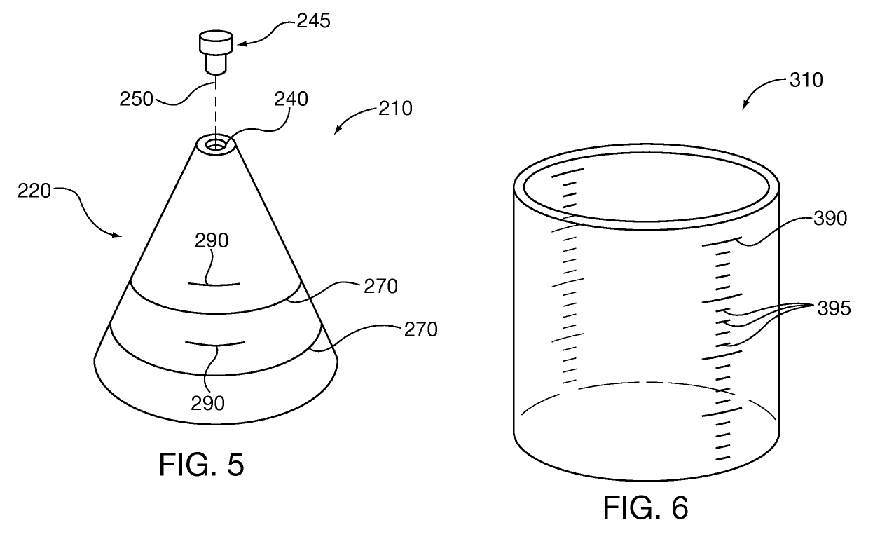

Referring now to FIG. 2, the food preparation and presentation cylinder with measurement indicia 10 can be made of PYREX™, any type of transparent polypropylene or any transparent material. PYREX™ is temperature resistant glassware that has properties that are well known to those skilled in the art. The types of transparent polypropylene that can be used are high density polypropylene (HDPE), medium density polypropylene (MDPE) and low density polypropylene (LDPE), all of which are also well known to those schooled in the related art. Transparency is an important feature of the food preparation and presentation cylinder with measurement indicia 10, since it allows people to view food F being prepared and or presented. The food preparation and presentation cylinder with measurement indicia 10 is also made of heat resistant material, is freezer safe, oven safe and microwave oven safe and is made of food grade materials. All of these features and attributes are also well known to those schooled in the art.

The food preparation and presentation cylinder with measurement indicia 10 can also be an entremet. An entremet, in modern French cuisine, is a small dish served between courses or simply a dessert. Originally it was an elaborate form of entertainment dish common among the nobility and upper middle class in Western Europe during the later part of the Middle Ages and the early modern period. The food preparation and presentation cylinder with measurement indicia 10 can also be used as a food mold and as previously mentioned, is made of food grade materials.

The food preparation and presentation cylinder with measurement indicia 10 has a plurality of circumferential rings 20 around the circumference of the food preparation and presentation cylinder with measurement indicia 10. The plurality of circumferential rings 20 each indicate a specific quantity of food (such as 8 ounces) or separation distance on the food preparation and presentation cylinder with measurement indicia 10 (such as 1″). The food presentation and presentation cylinder with measurement indicia 10 also has incremental etched markings 30 on a front side 40 and a back side 50 of the food preparation and presentation cylinder with measurement indicia 10. The food preparation and presentation cylinder with measurement indicia 10 can include only the plurality of circumferential rings 20, only the incremental etched markings 30 or a combination of both the plurality of circumferential rings 20 and incremental etched markings 30.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A food preparation and presentation cylinder with measurement indicia used for preparing and presenting food.

2. The cylinder according to claim 1, wherein said cylinder can be in the shape of a cube, a cone or other polygon.

3. The cylinder according to claim 1, wherein said cylinder is made of PYREX™, any type of transparent polypropylene or any transparent material.

4. The cylinder according to claim 1, wherein said types of transparent polypropylene include low density polypropylene (LDPE), medium density polypropylene (MDPE) and high density polypropylene (HDPE).

5. The cylinder according to claim 1, wherein said cylinder is made of heat resistant material.

6. The cylinder according to claim 1, wherein said cylinder is freezer safe, oven safe, microwave oven safe and is made of food grade material.

7. The cylinder according to claim 1, wherein said cylinder is an entremet.

8. The cylinder according to claim 1, wherein said cylinder is a food mold.

9. The cylinder according to claim 1, wherein said measurement indicia are a plurality of circumferential rings around the circumference of said cylinder.

10. The cylinder according to claim 9, wherein said circumferential rings each indicate a specific quantity of food or separation distance on said cylinder.

11. The cylinder according to claim 1, wherein said measurement indicia are incremental etched markings on a front side and a back side of said cylinder.
